(19) United States
(12) Patent Application Publication
(10) Pub. No.: US 2026/0339649 A1
(43) Pub. Date: Oct. 29, 2026

(54) INFORMATION PROCESSING APPARATUS, INFORMATION PROCESSING METHOD, AND INFORMATION PROCESSING RECORDING MEDIUM

(71) Applicant: Hitachi, Ltd., Tokyo (JP)

(72) Inventors: Soichiro Matsuo, Tokyo (JP); Shintaro Suzuki, Tokyo (JP); Akihiko Hyodo, Tokyo (JP)

(73) Assignee: Hitachi, Ltd., Tokyo (JP)

(21) Appl. No.: 19/541,580

(22) Filed: Feb. 17, 2026

(30) Foreign Application Priority Data
Apr. 25, 2025 (JP) 2025-073430

(51) Int. Cl. G06F 8/65; G06F 16/23; G06F 16/2457; G06N 5/025; G06N 20/00; G06Q 10/00; G06Q 10/06; G06Q 10/10

(52) U.S. Cl. CPC G06F 8/65; G06F 16/2379; G06F 16/24578; G06N 5/025; G06N 20/00; G06Q 10/00; G06Q 10/06; G06Q 10/10

(57) ABSTRACT

An information processing apparatus, which includes a processor that executes a program, and a storage device that stores the program, stores in the storage device an event detection rule for detecting an event based on a combination of satisfactions of conditions, and executes an identifying process of identifying an update candidate by applying a situation of a monitoring target to the event detection rule, the update candidate being a combination of an update target whose condition has not been satisfied in the event detection rule and update information that has made the condition of the update target in the situation unsatisfied, and a calculation process of calculating a priority for each update candidate identified through the identifying process.

### CLAIM OF PRIORITY

The present application claims priority from Japanese patent application No. 2025-073430 filed on Apr. 25, 2025, the content of which is hereby incorporated by reference into this application.

### BACKGROUND OF THE INVENTION

### 1. Field of the Invention

The present invention relates to an information processing apparatus and an information processing method that process information, and a recording medium.

### 2. Description of the Related Art

Business innovation incorporating digital technologies, such as the Internet of things (IoT) and generative artificial intelligence (AI), promotes improvements in business operations through promotion of business DX, and the labor shortage of front-line workers due to a declining birthrate and an aging population has become a serious problem.

In addition, while the implicit knowledge of skilled persons plays many roles, there is a labor shortage problem, and there is also a problem that the skills of the skilled persons are not sufficiently passed down. It is necessary to collect not only data and know-how registered in advance but also knowledge belonging to a person and knowledge known only by a skilled person, as explicit knowledge.

WO 2017/081715 A discloses an inference system that enables inference even when there is a shortage of knowledge. An input unit of the inference system receives an input of a start state and an end state. A rule candidate generation unit identifies each of a first state that is obtained by tracking one or more known rules from the start state and a second state that is obtained by backtracking one or more known rules from the end state. Then, the rule candidate generation unit generates a rule candidate related to the first state and the second state, or generates a rule candidate related to the first state and a rule candidate related to the second state. Then, the rule selection unit selects, based on feasibility of the generated rule candidate, which is calculated based on one or more known rules, the generated rule candidate as a new rule. A derivation unit performs a derivation process of deriving the end state from the start state, based on one or more known rules and the new rule.

### SUMMARY OF THE INVENTION

However, in WO 2017/081715 A, the rule candidate is calculated only from a score based on the similarity of states. Therefore, it is impossible to determine the similarity of states based on causal relations such as “high temperature” and “ice cream melting”. Thus, a gap occurs between inference performed based on the existing rule and an actual event.

When such a gap occurs, there is no index of which part of the rule should be updated and how to update the rule.

An object of the present invention is to provide appropriate update candidates when a gap occurs between inference performed based on an existing rule and an actual event.

An information processing apparatus according to an aspect of the invention disclosed in the present application is an information processing apparatus including a processor that executes a program, and a storage device that stores the program, in which the storage device stores an event detection rule for detecting an event based on a combination of satisfactions of conditions, and the processor executes an identifying process of identifying an update candidate by applying a situation of a monitoring target to the event detection rule, the update candidate being a combination of an update target whose condition has not been satisfied in the event detection rule and update information that has made the condition of the update target in the situation unsatisfied, and a calculation process of calculating a priority for each update candidate identified through the identifying process.

According to the representative embodiment of the present invention, it is possible to provide appropriate update candidates when a gap occurs between inference performed based on an existing rule and an actual event. Problems, configurations, and advantageous effects other than those described above will become apparent from the following description of the embodiment.

### BRIEF DESCRIPTION OF THE DRAWINGS

FIG. 1 is an explanatory diagram illustrating a system configuration example of an information processing system;

FIG. 2 is a block diagram illustrating a hardware configuration example of a computer;

FIG. 3 is an explanatory diagram illustrating an example of a digital twin DB;

FIG. 4 is an explanatory diagram illustrating an example of a rule DB;

FIG. 5 is a sequence diagram illustrating an example of an event inference sequence;

FIG. 6 is an explanatory diagram illustrating an event inference result and Comment Example 1;

FIG. 7 is an explanatory diagram illustrating an event inference result and Comment Example 2;

FIG. 8 is a sequence diagram illustrating an example of an update sequence for an event detection rule Ri;

FIG. 9 is a flowchart illustrating a detailed example of a processing procedure of a priority calculation process (step S803) illustrated in FIG. 8;

FIG. 10 is an explanatory diagram illustrating an example of identification of an update candidate in step S902;

FIG. 11 is an explanatory diagram illustrating an example of a result of evaluation performed with a first evaluation method: based on numerical similarity;

FIG. 12 is an explanatory diagram illustrating an example of a result of evaluation performed with the first evaluation method: based on semantic similarity;

FIG. 13 is an explanatory diagram illustrating an example of a result of evaluation performed with a second evaluation method;

FIG. 14 is an explanatory diagram illustrating an example of prompt generation (step S804) illustrated in FIG. 8;

FIG. 15 is an explanatory diagram illustrating an exemplary conversation between generative AI and a user;

FIGS. 16A to 16C are explanatory diagrams illustrating exemplary conversation patterns between generative AI and a user;

FIG. 17 is a flowchart illustrating an exemplary procedure of a verification process performed by an update apparatus;

FIG. 18 is an explanatory diagram illustrating a confusion matrix related to a pre-update event detection rule;

FIG. 19 is an explanatory diagram illustrating a confusion matrix related to a post-update event detection rule; and

FIG. 20 is an explanatory diagram illustrating an example of update of the event detection rule.

### DESCRIPTION OF THE PREFERRED EMBODIMENTS

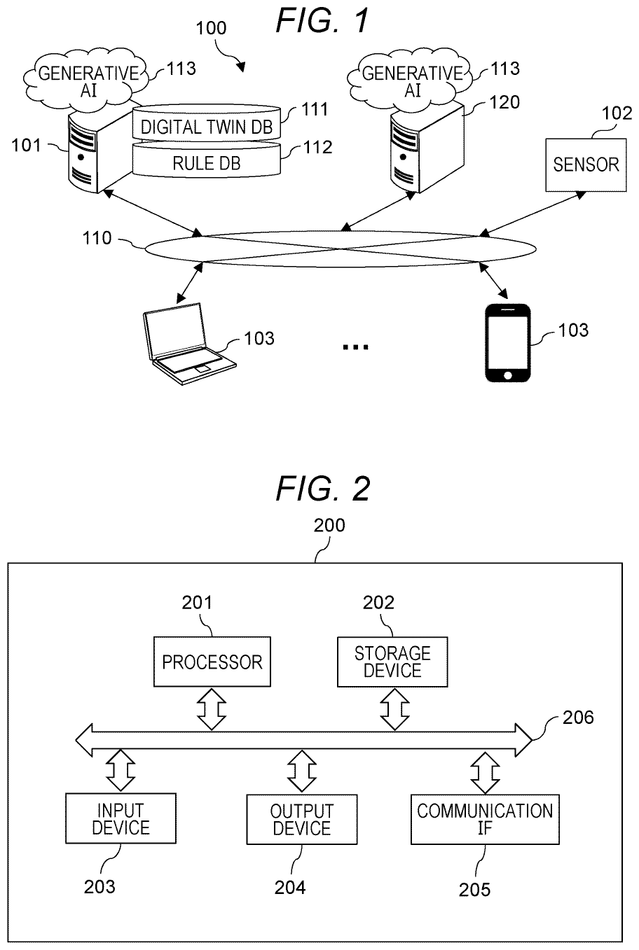

### FIG. 1: Configuration Example of Information Processing System

FIG. 1 is an explanatory diagram illustrating a system configuration example of an information processing system. An information processing system 100 includes an information processing apparatus 101, a sensor 102, and a communication terminal 103. The information processing apparatus 101 and the sensor 102 are communicably connected via a network 110 such as the Internet, a local area network (LAN), or a wide area network (WAN). The information processing apparatus 101 and the communication terminal 103 are communicably connected via the network 110.

The information processing apparatus 101 includes a digital twin DB 111, a rule DB 112, and generative AI 113. The digital twin DB 111 stores a digital twin of an external environment as a monitoring target. The rule DB 112 stores event detection rules. The generative AI 113 generates an answer upon receiving a prompt. The event detection rule is a rule for detecting an event based on a combination of satisfactions of conditions.

The generative AI 113 includes a language model trained by performing natural language processing using data set, and generates a sentence using the language model. The language model is a type of probability model used for natural language processing, and is a model for probabilistically predicting how a given word or sentence is likely to occur as a natural language. Specifically, the language model is a mathematical model for learning a language pattern, a grammatical rule, and the like in the field of natural language processing, and generating and understanding a natural language. For example, the generative AI 113 calculates the appearance probability of a given word string or sentence or compares the appearance probabilities of a plurality of word strings or sentences using the language model, thereby automatically generating the most likely word or sentence based on the context when predicting a next word or sentence.

As described above, upon receiving an inquiry called a prompt, the generative AI 113 outputs an answer to the inquiry using the language model that has learned a huge amount of data sets.

The sensor 102 detects the condition of an external environment as a monitoring target, and transmits the obtained detection data to the information processing apparatus 101. Examples of the sensor 102 include a camera, a temperature sensor, a humidity sensor, an infrared sensor, a noise sensor, an illuminance sensor, a motion sensor, an ultrasonic sensor, a dust sensor, and a vibration sensor.

The communication terminal 103 is a computer that transmits data input through a user operation to the information processing apparatus 101 via the network 110, and receives data from the information processing apparatus 101 via the network 110 and displays the data.

The information processing apparatus 101 may be communicably connected to an external server 120 via the network 110. The server 120 may have generative AI 113 mounted thereon. Upon receiving a prompt from the information processing apparatus 101, the generative AI 113 transmits an answer to the inquiry to the information processing apparatus 101 using the language model that has been learned a huge amount of data sets.

In addition, the server 120 may acquire weather data, such as a change in temperature or atmospheric pressure occurring in the atmosphere, rainy, windy, typhoon, snowy, or thunder over time, and transmit the weather data to the information processing apparatus 101.

### FIG. 2: Hardware Configuration Example of Computer (i.e., Information Processing Apparatus 101, Communication Terminal 103, and Server 120)

FIG. 2 is a block diagram illustrating a hardware configuration example of a computer. The computer 200 includes a processor 201, a storage device 202, an input device 203, an output device 204, and a communication interface (i.e., communication IF) 205. The processor 201, the storage device 202, the input device 203, the output device 204, and the communication IF 205 are connected via a bus 206. The processor 201 controls the computer 200. The storage device 202 serves as a work area for the processor 201. The storage device 202 is a non-transitory or transitory recording medium that stores various programs and data. Examples of the storage device 202 include a read only memory (ROM), a random access memory (RAM), a hard disk drive (HDD), and a flash memory. The input device 203 inputs data. Examples of the input device 203 include a keyboard, a mouse, a touch panel, a numeric keypad, a scanner, a microphone, and a sensor. The output device 204 outputs data. Examples of the output device 204 include a display, a printer, and a speaker. The communication IF 205 is connected to the network 110 to transmit and receive data.

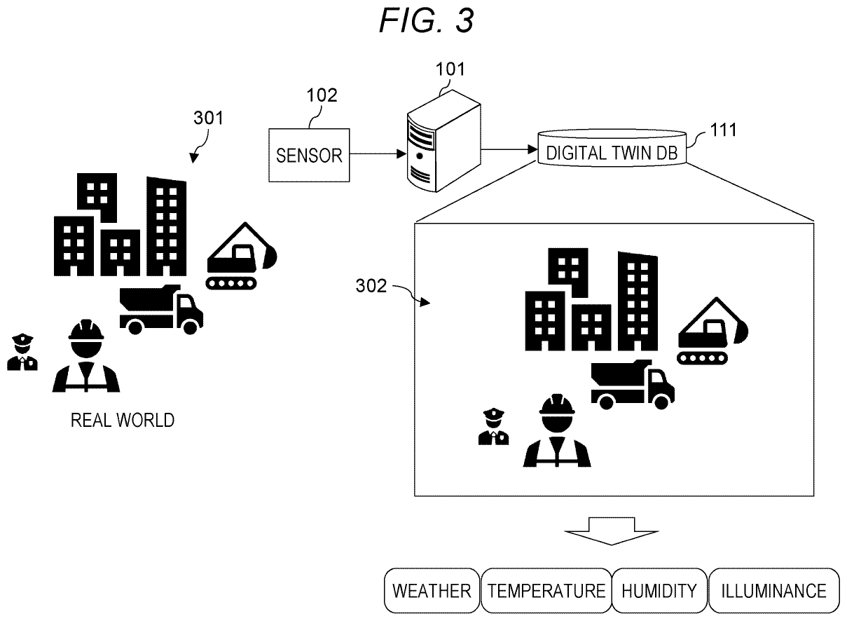

### FIG. 3: Digital Twin DB 111

FIG. 3 is an explanatory diagram illustrating an example of the digital twin DB 111. FIG. 3 illustrates an example of update of a digital twin 302 of a work site 301 in the real world as an example of scene information. The digital twin DB 111 stores the digital twin 302 that is a three-dimensional model based on the structure of the work site 301. When the sensor 102 detects weather, temperature, humidity, and illuminance, which are current situation information on the work site 301, for example, the information processing apparatus 101 updates the digital twin 302 by giving the detection data from the sensor 102 to the digital twin 302. That is, time-series detection data from the sensor 102 is held in the digital twin DB 111. In this manner, the digital twin DB 111 holds a series of past digital twins 302 or information that can reproduce the series of past digital twins 302.

Although FIG. 3 illustrates an example in which weather, temperature, humidity, and illuminance are detected, detection data other than these may be used. In addition, the information processing apparatus 101 may execute a specific process based on the detection data. For example, when the presence and the position of a person are detected by the motion sensor, the information processing apparatus 101 may detect whether the person is a worker through a face recognition process. Although the digital twin 302 is applied in the present embodiment, the information processing apparatus 101 may use the detection data from the sensor 102 as the scene information without applying the digital twin 302.

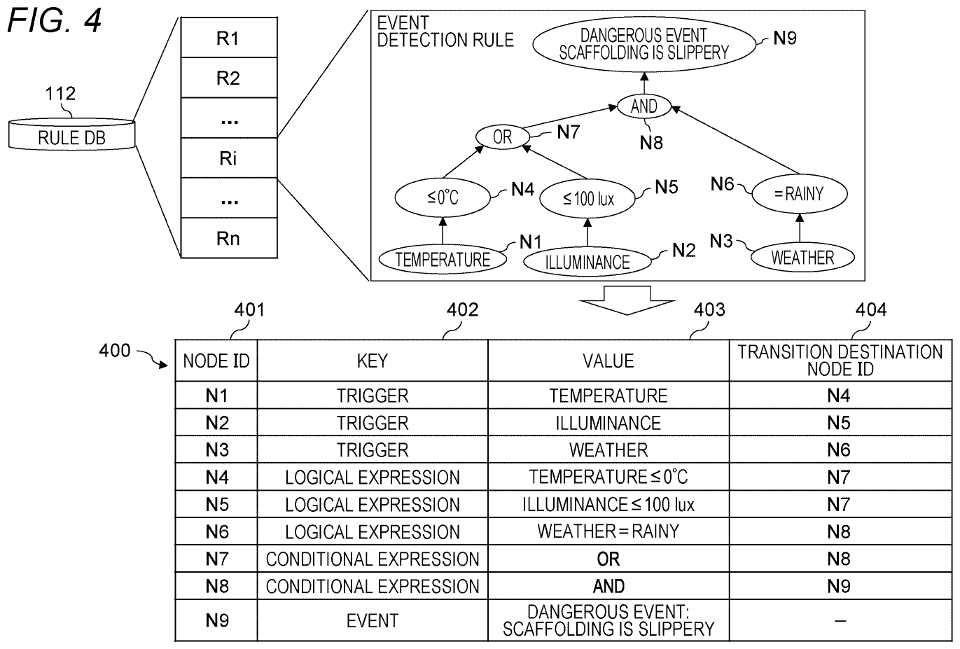

### FIG. 4: Rule DB 112

FIG. 4 is an explanatory diagram illustrating an example of the rule DB 112. The rule DB 112 stores one or more event detection rules R1 to Rn (n is an integer of 1 or more). For example, an event detection rule Ri (i is an integer satisfying 1≤i≤n) is tree structure data including nodes N1 to N9 and directed edges connecting the nodes. When the nodes N1 to N9 are not distinguished, they are represented as nodes N. When the rule Ri is expanded, it is expressed as expanded data 400.

The node N indicates a condition necessary for detecting an event. When the condition is satisfied, the condition determination process transitions to a transition destination node N. Specifically, the node N includes a node ID 401, a key 402, a value 403, and a transition destination node ID 404, for example. The node ID 401 is identification information for uniquely identifying the node N. In this example, the symbol of the node N is used as the node ID 401.

The key 402 indicates the type of the node N. Examples of the key 402 include a trigger, a logical expression, a conditional expression, and an event. The value 403 is detailed information on the key 402. The transition destination node ID 404 is the node ID 401 of a node N as the transition destination of the current node N. In the rule Ri, the start point of a directed edge corresponds to the transition source node N, and the end point of the directed edge corresponds to the transition destination node N from the transition source node N.

Regarding the node N1, the key 402 indicates “Trigger”, the value 403 indicates “Temperature”, and the transition destination node ID 404 indicates “N4”. Thus, the node N1 indicates the detection data of the temperature sensor that is to be output to the node N4. Regarding the node N2, the key 402 indicates “Trigger”, the value 403 indicates “Illuminance”, and the transition destination node ID 404 indicates “N5”. Thus, the node N2 indicates the detection data of the illuminance sensor that is to be output to the node N5. Regarding the node N3, the key 402 indicates “Trigger”, the value 403 indicates “Weather”, and the transition destination node ID 404 indicates “N6”. Thus, the node N3 indicates the weather included in the weather data from the server 120 that is to be output to the node N6.

Regarding the node N4, the key 402 indicates “Logical Expression”, the value 403 indicates “Temperature ≤0 °C”, and the transition destination node ID 404 indicates “N7”. Thus, the node N4 indicates that it will transition to the node N7 when the temperature from the node N1 is “≤0 °C”.

Regarding the node N5, the key 402 indicates “Logical Expression”, the value 403 indicates “Illuminance≤100 lux”, and the transition destination node ID 404 indicates “N7”. Thus, the node N5 indicates that it will transition to the node N7 when the illuminance from the node N2 is “≤100 lux”.

Regarding the node N6, the key 402 indicates “Logical Expression”, the value 403 indicates “Weather=Rainy”, and the transition destination node ID 404 indicates “N8”. Thus, the node N6 indicates that it will transition to the node N8 when the weather from the node N3 is “=Rainy”.

Regarding the node N7, the key 402 indicates “Conditional Expression”, the value 403 indicates “OR”, and the transition destination node ID 404 indicates “N8”. Thus, the node N7 indicates that it will transition to the node N8 when there is transition from one of the nodes N4 and N5.

Regarding the node N8, the key 402 indicates “Conditional Expression”, the value 403 indicates “AND”, and the transition destination node ID 404 indicates “N9”. Thus, the node N8 indicates that it will transition to the node N9 when there is transition from both of the nodes N6 and N7.

Regarding the node N9, the key 402 indicates “Event”, the value 403 indicates “Dangerous Event: Scaffolding is Slippery”, and the transition destination node ID 404 indicates “-”. Thus, the node N9 outputs a message: “Dangerous Event: Scaffolding is Slippery”, that is, the node N9 indicates that an event is detected when there is transition from the node N8.

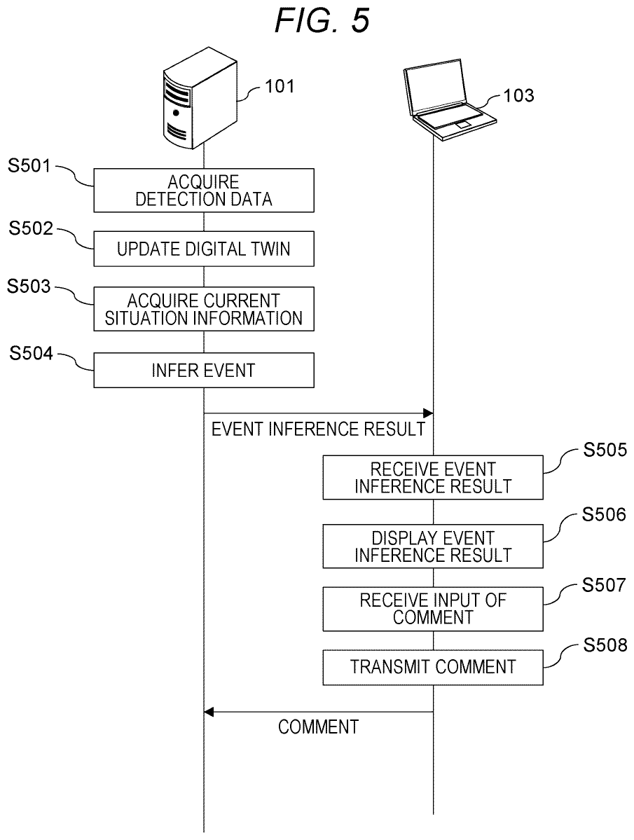

### FIG. 5: Event Inference Sequence

FIG. 5 is a sequence diagram illustrating an example of an event inference sequence. The event inference sequence is a process in which the information processing apparatus 101 infers an event, and a user returns a comment from the communication terminal 103 in response to the result of the event inference.

### (Step S501)

The information processing apparatus 101 acquires detection data from the sensor 102. The timing of acquiring the detection data may be a predetermined time interval, may be a detection timing of the sensor 102, or may be a timing at which the communication terminal 103 accesses the information processing apparatus 101.

### (Step S502)

The information processing apparatus 101 updates the digital twin 302 based on the detection data acquired in step S501.

### (Step S503)

The information processing apparatus 101 acquires current situation information from the digital twin 302 updated in step S502. The current situation information is information indicating the current situation of the monitoring target. In the above example, the current situation information corresponds to the temperature, illuminance, and weather at the work site 301 obtained from the digital twin 302.

### (Step S504)

The information processing apparatus 101 applies the current situation information to the event detection rule Ri to execute an inference process of inferring an event, and then transmits the result of the event inference to the communication terminal 103 of the user.

### (Step S505)

The communication terminal 103 receives the event inference result from the information processing apparatus 101.

### (Step S506)

The communication terminal 103 displays the event inference result.

### (Step S507)

The communication terminal 103 receives an input of a comment from the user. The comment is text data indicating a reaction of the user to the event inference result.

### (Step S508)

The communication terminal 103 transmits the comment to the information processing apparatus 101.

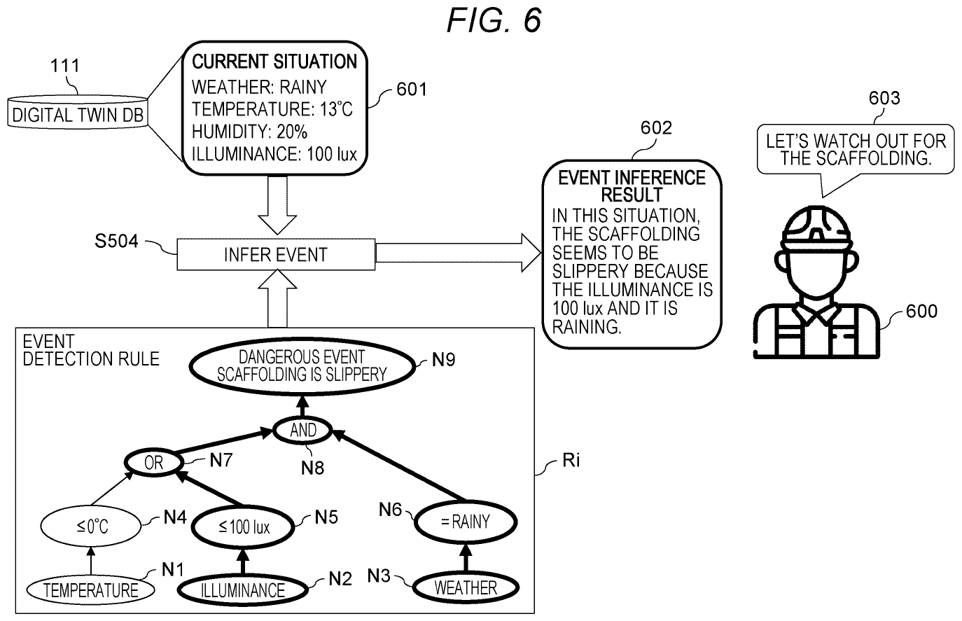

### FIG. 6: Event Inference Result and Comment Example 1

FIG. 6 is an explanatory diagram illustrating an event inference result and Comment Example 1. FIG. 6 illustrates an example of the comment input by the user in step S507 when an event is detected with the event detection rule Ri in the event inference (step S504).

In the event inference (step S504), the information processing apparatus 101 obtains current situation information 601 from the digital twin 302, and applies the current situation information 601 to the event detection rule Ri. The current situation information 601 is a set of detection data including, for example, weather: rainy, temperature: 13 °C, humidity: 20%, and illuminance: 100 lux.

When the current situation information 601 is applied to the event detection rule Ri, the conditional expression of the node N8 is satisfied through the node transition of N2⇒N5⇒N7⇒N8 and the node transition of N3⇒N6⇒N8, and thus, a dangerous event indicated by the node N9 is detected. Therefore, the information processing apparatus 101 transmits to the communication terminal 103 a message: “In this situation, the scaffolding seems to be slippery because the illuminance is 80 lux and it is raining.” as an event inference result 602.

The event inference result 602 is displayed on the communication terminal 103. A user 600 confirms the event inference result 602, and inputs a message: “Let's watch out for the scaffolding.” into the communication terminal 103 as a comment 603. The communication terminal 103 transmits the comment 603 to the information processing apparatus 101.

FIG. 6 illustrates that there is no gap between the event inference result 602 and the event corresponding to the current situation information 601.

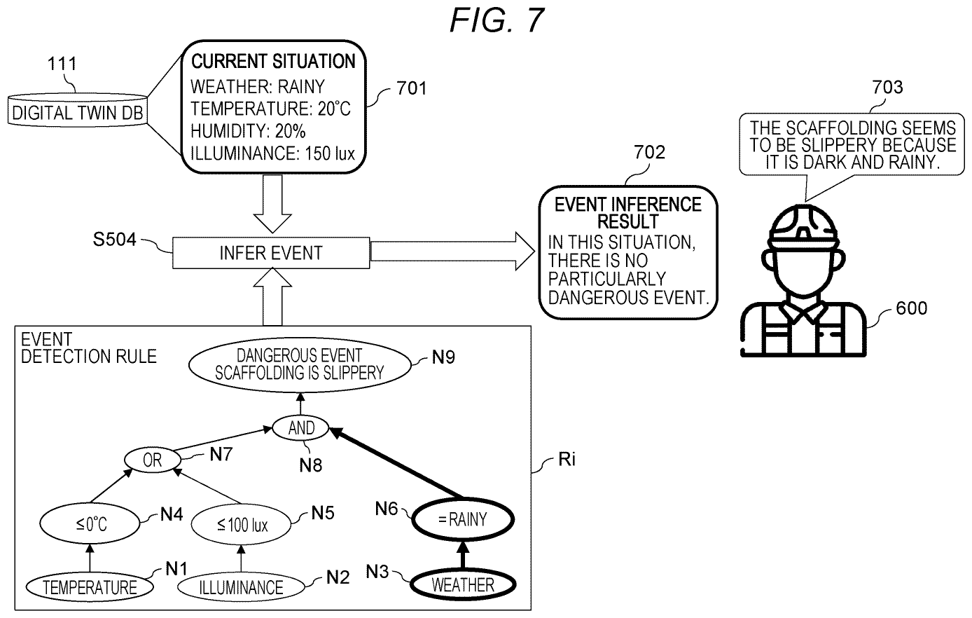

### FIG. 7: Event Inference Result and Comment Example 2

FIG. 7 is an explanatory diagram illustrating an event inference result and Comment Example 2. FIG. 7 illustrates an example of the comment input by the user in step S507 when an event is detected with the event detection rule Ri in the event inference (step S504).

In the event inference (step S504), the information processing apparatus 101 obtains current situation information 701 from the digital twin 302, and applies the current situation information to the event detection rule Ri. The current situation information 701 is a set of detection data including, for example, weather: rainy, temperature: 20 °C, humidity: 20%, and illuminance: 150 lux.

When the current situation information 701 is applied to the event detection rule Ri, the conditional expression of the node N8 is not satisfied through the node transition of N3⇒N6⇒N8, and thus, a dangerous event indicated by the node N9 is not detected. Therefore, the information processing apparatus 101 transmits to the communication terminal 103 a message: “In this situation, there is no particularly dangerous event.” as an event inference result 702.

The event inference result 702 is displayed on the communication terminal 103. The user 600 confirms the event inference result 702. If the user 600 does not agree with the event inference result 702, for example, the user 600 inputs a message: “The scaffolding seems to be slippery because it is dark and rainy.” into the communication terminal 103 as a comment 703. The communication terminal 103 transmits the comment 703 to the information processing apparatus 101.

FIG. 7 illustrates that there is a gap between the event inference result 702 and the event corresponding to the current situation information 701.

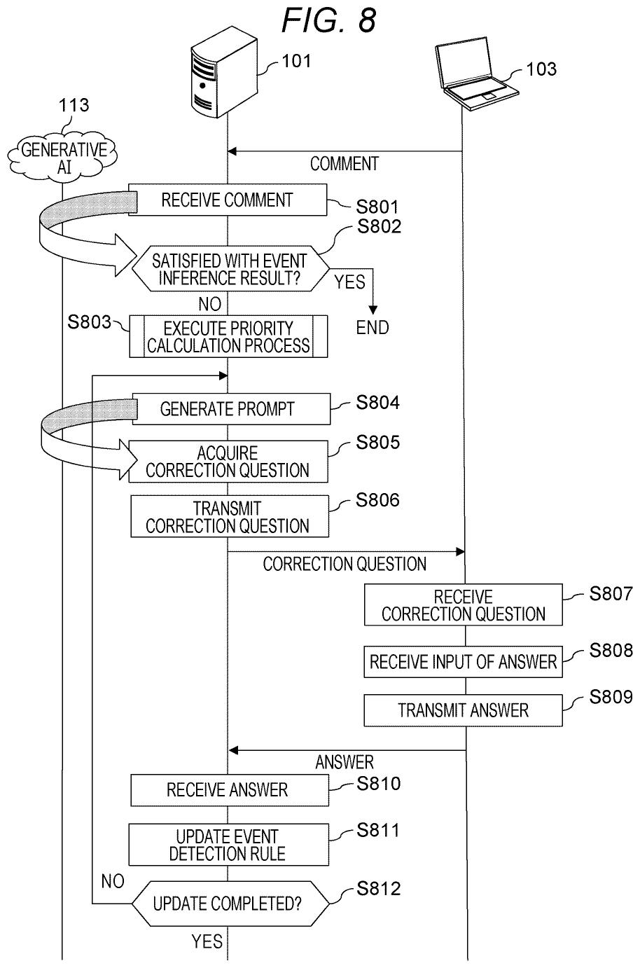

### FIG. 8: Update Sequence for Event Detection Rule Ri

FIG. 8 is a sequence diagram illustrating an example of an update sequence for the event detection rule Ri. FIG. 8 is executed following the sequence of FIG. 5.

### (Step S801)

The information processing apparatus 101 receives the comment transmitted from the communication terminal 103 in step S508. The received comment corresponds to the comments 603 and 703 illustrated in FIGS. 6 and 7, respectively. In this manner, through the processes of steps S505 to S508 and S801, the information processing apparatus 101 executes a first acquisition process of acquiring a comment indicating a reaction to the event inference result as a result of the event inference result having been output from the information processing apparatus 101.

### (Step S802)

The information processing apparatus 101 executes a determination process of determining whether the comment received in step S801 has content satisfied with the event inference result. Specifically, for example, the information processing apparatus 101 generates a prompt for asking whether the comment has content satisfied with the event inference result, and outputs the prompt to the generative AI 113, and then acquires an answer thereto from the generative AI 113. The information processing apparatus 101 determines whether the comment has content satisfied with the event inference result based on the acquired answer.

Regarding the example of FIG. 6, in the case of a combination of the event inference result 602 and the comment 603 of FIG. 6, the information processing apparatus 101 determines that the comment 603 has content satisfied with the event inference result 602. Meanwhile, regarding the example of FIG. 7, in the case of a combination of the event inference result 702 and the comment 703 of FIG. 7, the information processing apparatus 101 determines that the comment 703 has content not satisfied with the event inference result 702.

If the information processing apparatus 101 determines that the comment has content satisfied with the event inference result (step S802: Yes), the information processing apparatus 101 ends the series of processes. Meanwhile, if the information processing apparatus 101 determines that the comment has content not satisfied with the event inference result (step S802: No), the process proceeds to step S803.

### (Step S803)

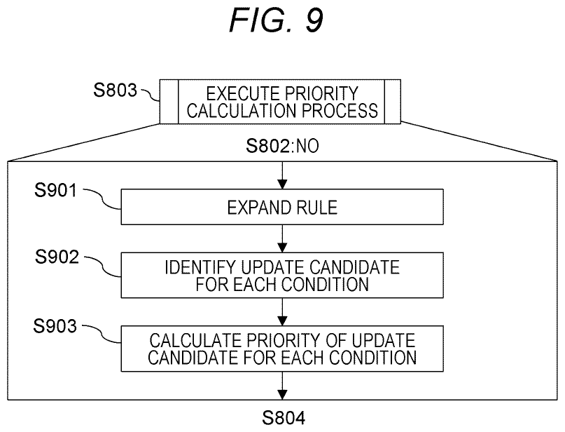

The information processing apparatus 101 executes a priority calculation process. The priority calculation process (step S803) is a process of identifying a node N as an update candidate from the event detection rule Ri, and calculating the priority of the update candidate. Details of the priority calculation process (step S803) will be described later with reference to FIG. 9.

### (Step S804)

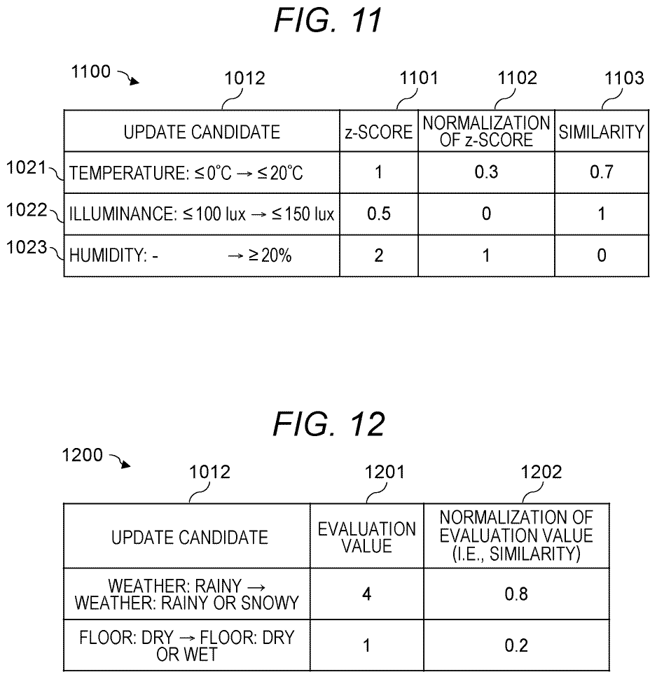

The information processing apparatus 101 executes a generation process of generating a prompt for requesting a question for correcting the event detection rule Ri (hereinafter, a correction question). Specifically, for example, the information processing apparatus 101 generates the prompt based on the event inference result, the current situation information, the update candidate, and its priority. The information processing apparatus 101 outputs the generated prompt to the generative AI 113. The prompt will be described later with reference to FIG. 11.

### (Step S805)

As a result of transmitting the prompt generated in step S804 to the generative AI 113, the information processing apparatus 101 executes a second acquisition process of acquiring a correction question as an answer from the generative AI 113.

### (Step S806)

The information processing apparatus 101 transmits to the communication terminal 103 the correction question received in step S805.

### (Step S807)

The communication terminal 103 receives the correction question transmitted from the information processing apparatus 101 in step S806.

### (Step S808)

The communication terminal 103 receives an input of an answer to the correction question received in step S807, through an operation of the user 600.

### (Step S809)

The communication terminal 103 transmits to the information processing apparatus 101 the answer input in step S808.

### (Step S810)

The information processing apparatus 101 receives the answer transmitted from the communication terminal 103 in step S809. As described above, through the processes of steps S806 to S810, the information processing apparatus 101 executes a third acquisition process of, as a result of outputting a correction question acquired through the second acquisition process, acquiring an answer to the correction question.

### (Step S811)

The information processing apparatus 101 executes an update process of updating the event detection rule Ri based on the answer received in step S810. In such a case, the information processing apparatus 101 may generate a prompt for determining a request of the user 600 (i.e., whether to update the event detection rule Ri) using the answer, and output the generated prompt to the generative AI 113. Then, if an answer from the generative AI 113 indicates that the event detection rule Ri should be updated, the information processing apparatus 101 may execute step S811.

### (Step S812)

The information processing apparatus 101 determines whether the update of the event detection rule Ri is complete. If the update of the event detection rule Ri is not complete (step S812: No), the information processing apparatus 101 and the communication terminal 103 repeatedly execute steps S804 to S811 until the update of the event detection rule Ri is completed (step S812: Yes). If the update of the event detection rule Ri is complete (step S812: Yes), the series of processes ends.

### FIG. 9: Priority Calculation Process (Step S803)

FIG. 9 is a flowchart illustrating a detailed example of a processing procedure of the priority calculation process (step S803) illustrated in FIG. 8.

### (Step S901)

The information processing apparatus 101 executes rule expansion. Specifically, for example, the information processing apparatus 101 generates the expanded data 400 from the event detection rule Ri. Note that the information processing apparatus 101 may generate the expanded data 400 in advance and store the expanded data 400 in the storage device 202, and then read the expanded data 400 at the stage of step S901.

### (Step S902)

The information processing apparatus 101 executes an identifying process of identifying an update candidate for each condition under which the event detection rule Ri is satisfied. Specifically, for example, the information processing apparatus 101 identifies a condition pattern that satisfies the node N9 whose key 402 indicates an event. In the case of the event detection rule Ri, there are two condition patterns. The first is a combination (hereinafter, a first condition pattern) of a path from the node N1 to the node N8 via the node N7 and a path from the node N3 to the node N8 via the node N6, and the second is a combination (hereinafter, a second condition pattern) of a path from the node N2 to the node N8 via the node N7 and a path from the node N3 to the node N8 via the node N6.

For each condition pattern, the information processing apparatus 101 identifies as an update target a node N whose condition has not been satisfied by the application of an element of the current situation information, and also identifies as update information the element of the current situation information that has made the condition of the node N, which is the update target, unsatisfied. A combination of the update target and the update information is referred to as an update candidate. Hereinafter, step S902 will be specifically described.

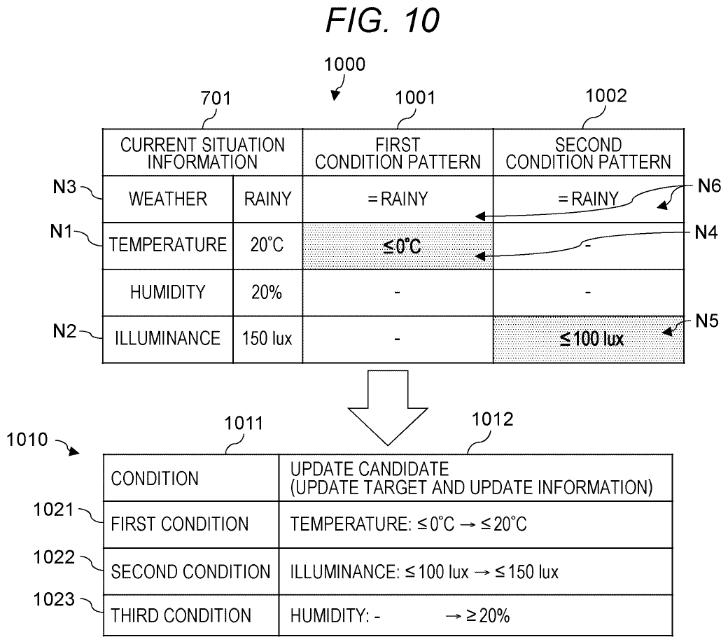

### FIG. 10: Example of Identification of Update Candidate

FIG. 10 is an explanatory diagram illustrating an example of identification of an update candidate in step S902. FIG. 10 illustrates an example of a case where, regarding the combination of the event inference result 702 and the comment 703 illustrated in FIG. 7, the information processing apparatus 101 determines that the comment 703 has content not satisfied with the event inference result 702.

The condition determination information 1000 includes, as fields, the current situation information 701, a first condition pattern 1001, and a second condition pattern 1002. In the current situation information 701, temperature, illuminance, and weather correspond to the nodes N1 to N3, respectively. In the column of the first condition pattern 1001, a cell with a white background indicates a node N whose condition regarding the current situation information 701 is satisfied. For example, in both the first condition pattern 1001 and the second condition pattern 1002, the weather regarding the current situation information 701 is rainy. Thus, the node N6 is satisfied. Note that a cell “-” indicates a condition where the nodes N4 to N6 whose keys 402 indicate “logical expressions” are not present in the first condition pattern 1001 or the second condition pattern 1002.

A hatched cell indicates a node N whose condition regarding the current situation information 701 is not satisfied. For example, since the temperature of the current situation information 701 is 20 °C, the node N4 in the first condition pattern 1001 is not satisfied. Similarly, since the illuminance of the current situation information 701 is 150 lux, the node N5 in the second condition pattern 1002 is not satisfied.

The information processing apparatus 101 generates an update candidate identification result 1010 based on the condition determination information 1000. The update candidate identification result 1010 includes an update candidate 1012 for each condition 1011. The update candidate 1012 is a combination of an update target and update information. The update target is a node N of the event detection rule Ri whose condition is not satisfied regarding the update information. The update information is an element of the current situation information that has made the condition of the update target unsatisfied.

Specifically, for example, a first update candidate 1021 indicates that, regarding the first condition pattern 1001, the node N4 with “temperature ≤0 °C” is the update target of the update candidate 1012, and the temperature “20 °C” included in the current situation information 701 is the update information, and thus, “0 °C” of the update target “temperature ≤0 °C” should be updated to the update information “20 °C”.

A second update candidate 1022 indicates that, regarding the second condition pattern 1002, the node N5 with “illuminance ≤100 lux” is the update target of the update candidate 1012, and the illuminance “150 lux” included in the current situation information 701 is the update information, and thus, “100 lux” of the update target “illuminance ≤100 lux” should be updated to the update information “150 lux”.

A third update candidate 1023 indicates that, regarding a third condition, the humidity “-” not included in the event detection rule Ri is the update target of the update candidate 1012, and the humidity “20%” included in the current situation information 701 is the update information, and thus, the update target “-” should be updated to a humidity of “≥20%”. As a method of giving the inequality sign “≥”, the information processing apparatus 101 may employ a method of generating the following prompt, and outputting the prompt to the generative AI 113, and then acquiring an answer from the generative AI 113, for example.

Prompt: “Which one of a humidity of ≥20% and a humidity of ≤20% is suitable as a cause for the event ‘Scaffolding is Slippery’?” It is assumed that an answer from the generative AI 113 in such a case is a humidity of “≥20%”.

In addition, the information processing apparatus 101 may count each of cases of a “humidity of ≥20%” and a “humidity of ≤20%” with reference to the occurrence history of past events as well as the situations (i.e., humidity in this example) at those times in the digital twin DB 111, and determine the direction of the inequality sign so as to include many occurrence situations of the past events.

### (Step S903)

Referring back to FIG. 9, the information processing apparatus 101 executes a calculation process of calculating the priority of the update candidate 1012 for each condition. The priority is an index value indicating which update candidate 1012 should be preferentially updated, and is a value obtained by quantifying likelihood for each condition. For the calculation of the priority, for example, a first evaluation method of evaluating similarity of events and a second evaluation method of evaluating the likelihood (i.e., causal inference) of update for each condition are used. The first evaluation method includes evaluation based on numerical similarity and evaluation based on semantic similarity of terms.

Regarding the first evaluation method, if the update candidate 1012 is determined based on a numerical value, such as temperature or humidity, evaluation based on numerical similarity is applied, and if the update candidate 1012 is determined based on a category value, such as weather, evaluation based on semantic similarity of terms is applied. For example, since numerical comparison is executed for the first update candidate 1021 to the third update candidate 1023 as the update candidates 1012 of FIG. 10, evaluation based on numerical similarity is applied. A specific description will be given below.

### FIG. 11: First Evaluation Method: Evaluation Based on Numerical Similarity

FIG. 11 is an explanatory diagram illustrating an example of a result of evaluation performed with the first evaluation method: based on numerical similarity. The evaluation performed based on numerical similarity as the first evaluation method is a method of statistically analyzing numerical values of detection data that is each trigger, such as temperature, humidity, or illuminance, to evaluate a difference based on a variance of the detection data.

An evaluation result 1100 includes the update candidate 1012, a z-score 1101, normalization 1102 of the z-score, and similarity 1103 for each of the first update candidate 1021 to the third update candidate 1023. The z-score 1101 is an evaluation index based on numerical similarity, and is calculated from z=(x−μ)/s, where x is the numerical value of the detection data, μ is the mean value thereof, and s is the standard deviation thereof.

As the z-scores 1101 are closer, it is possible to consider that the values of the update candidate 1012 before and after the update are similar. As an example, it is assumed that the mean μ1 of the temperature=25, the standard deviation s1 of the temperature=5, the mean μ2 of the illuminance=500, and the standard deviation s2 of the illuminance=100. Note that the numerical value before the update is a numerical value indicated by the update target (i.e., the node N) in the update candidate 1012, and the numerical value after the update is a numerical value indicated by the update information (i.e., an element of the current situation information 701) in the update candidate 1012.

Regarding the first update candidate 1021, the z-score 1101 of the temperature: 0 °C before the update is represented by:

z=(0−25)/5=−5.

Regarding the first update candidate 1021, the z-score 1101 of the temperature: 20 °C after the update is represented by:

z=(20−25)/5=−1.

Regarding the first update candidate 1021, a difference d1 between the z-scores 1101 of the temperatures (0 °C-20 °C) before and after the update is represented by:

d1=|(−5)−(−1)|=4.

Similarly, regarding the second update candidate 1022, the z-score 1101 of the illuminance: 100 lux before the update is represented by:

z=(100−500)/100=−4.

Regarding the second update candidate 1022, the z-score 1101 of the illuminance: 150 lux after the update is represented by:

z=(150−500)/100=−3.5.

Regarding the second update candidate 1022, a difference d2 between the z-scores 1101 of the illuminance (100 lux-150 lux) before and after the update is represented by:

d2=|(−4)−(−3.5)|=0.5.

Since the difference d2 is smaller than the difference d1, it is evaluated that the values of illuminance before and after the update are more similar than the values of temperature before and after the update. When the differences d1 and d2 are not distinguished, the they are represented as difference d.

The information processing apparatus 101 sets, as the normalization 1102 of the z-score, a value obtained by normalizing the difference d to be in the range of a maximum value of 1 and a minimum value of 0. The information processing apparatus 101 calculates the similarity 1103 of the values of the update candidate 1012 before and after the update by subtracting the normalization 1102 of the z-score from 1. A larger value of the similarity 1103 indicates that the values before and after the update are more similar. When there is no value before update as in the third update candidate 1023, the z-score 1101 is calculated with the value of humidity before update as 0%.

### FIG. 12: First Evaluation Method: Evaluation Based on Semantic Similarity of Terms

FIG. 12 is an explanatory diagram illustrating an example of a result of evaluation performed with the first evaluation method: based on semantic similarity of terms. The evaluation performed based on the semantic similarity of terms as the first evaluation method is, for example, a method of analyzing detection data on a trigger having a category value, such as weather, to evaluate a difference before and after update. The method of calculating the difference is, for example, evaluation (e.g., five-grade evaluation) executed based on the general knowledge of the generative AI 113.

An evaluation result 1200 includes the update candidate 1012, an evaluation value 1201, and normalization 1202 of the evaluation value. The update candidate 1012 serves as a prompt generation source. A prompt is an inquiry sentence for requesting the evaluation of the similarity of the values of the update candidate 1012 before and after update, and is generated by setting the values before and after update on a prompt template.

Hereinafter, the nodes N3 and N6 indicating the weather of the event detection rule Ri will be described as examples. The value 403 before update of the node N6 indicates “Weather=Rainy”. It is assumed that the weather in the current situation information indicates “Snowy”. In such a case, the information processing apparatus 101 generates the following prompt by setting “Rainy” as a value before update and setting “Rainy or Snowy” as an updated value on the prompt template, and outputs the prompt to the generative AI 113.

Prompt: “Please evaluate the similarity of the following environmental conditions in five levels:
‘Weather: Rainy’ and ‘Weather: Snowy’”.

It is assumed that the evaluation value 1201, which is an answer from the generative AI 113 in such a case, is “4”.

In addition, it is assumed that there is a node N that is not included in the event detection rule Ri but indicates the state of a floor. It is also assumed that the value 403 before update of the node N is “Floor=Dry”. It is also assumed that the current situation information indicates “Floor=Wet”. In such a case, the information processing apparatus 101 generates the following prompt by setting “Dry” as a value before update and setting “Dry or Wet” as an updated value on the prompt template.

Prompt: “Please evaluate the similarity of the following environmental conditions in five levels:
‘Floor: Dry’ and ‘Floor: Wet’”.

It is assumed that the evaluation value 1201, which is an answer from the generative AI 113 in such a case, is “1”.

The information processing apparatus 101 normalizes the evaluation value 1201 to be in the range of 0 to 1 to acquire the normalization 1202 of the evaluation value. The information processing apparatus 101 may cause the generative AI 113 to execute the acquisition of the normalization 1202 of the evaluation value.

Besides, the information processing apparatus 101 may convert the values 403 before and after update into vector expressions in which the respective values are embedded, and calculate the cosine similarity thereof as the evaluation value 1201. In such a case, the information processing apparatus 101 normalizes the evaluation value 1201 (i.e., cosine similarity) to be in the range of 0 to 1 to acquire the normalization 1202 of the evaluation value.

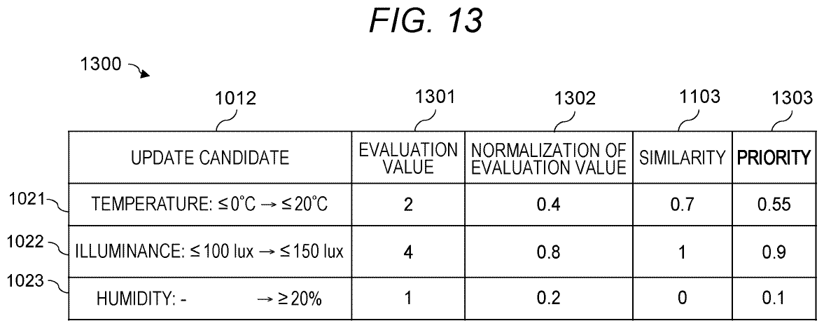

### FIG. 13: Result of Evaluation Performed with Second Evaluation Method

FIG. 13 is an explanatory diagram illustrating an example of a result of evaluation performed with the second evaluation method. The evaluation of the likelihood (i.e., causal inference) of update for each condition performed with the second evaluation method is, for example, evaluation (e.g., five-grade evaluation) executed based on the general knowledge of the generative AI 113.

An evaluation result 1300 includes the update candidate 1012, an evaluation value 1301, normalization 1302 of the evaluation value, similarity 1103, and priority 1303. The update candidate 1012 serves as a prompt generation source. The prompt is an inquiry sentence for requesting the evaluation of the likelihood (i.e., causal inference) of update for the update candidate 1012 of an event, and is generated by setting the event as well as an updated value on the prompt template.

Hereinafter, the event detection rule Ri will be described as an example. An event of the event detection rule Ri is “Dangerous Event: Scaffolding is Slippery” of the node N9. The updated value 403 of the temperature corresponds to “20 °C” of the current situation information 701. The updated value 403 of the illuminance corresponds to “150 lux” of the current situation information 701. The updated value of the humidity corresponds to the humidity “20%” of the current situation information 701.

In such a case, the information processing apparatus 101 generates the following prompt by setting “Temperature: 20 °C”, “Illuminance: 150 lux”, and “Humidity: 20%” as updated values on the prompt template, and outputs the prompt to the generative AI 113.

Prompt: “The following event and events that are considered as their possible candidate causes are given: Please evaluate the likelihood of each candidate cause in five levels.
Event: ‘Scaffolding is Slippery’
Candidate Cause 1: ‘Temperature: ≤20 °C’
Candidate Cause 2: ‘Illuminance: ≤150 lux’
Candidate Cause 3: ‘Humidity: ≥20%’”.

It is assumed that the evaluation value 1301, which is an answer from the generative AI 113 in such case, is assumed to be “2” for the first update candidate 1021, “4” for the second update candidate 1022, and “1” for the third update candidate 1023.

The information processing apparatus 101 normalizes the evaluation value 1301 to be in the range of 0 to 1 to acquire the normalization 1302 of the evaluation value. The information processing apparatus 101 may cause the generative AI 113 to execute the acquisition of the normalization 1302 of the evaluation value.

For each of the first update candidate 1021 to the third update candidate 1023, the information processing apparatus 101 calculates the priority 1303 using the normalization 1302 of the evaluation value and the similarity 1103 (step S903). The priority 1303 is, for example, the mean value of the normalization 1302 of the evaluation value and the similarity 1103.

In FIG. 13, the update candidates 1012 including the first update candidate 1021 to the third update candidate 1023 are defined by numerical values, but at least one update candidate 1012 of the first update candidate 1021 to the third update candidate 1023 may be defined by a category value. For example, when at least one update candidate 1012 of the first update candidate 1021 to the third update candidate 1023 is defined by a category value, such as “Weather: Rainy→Weather: Rainy or Snowy”, as illustrated in FIG. 12, the evaluation value 1201 indicates “4”, and the normalization 1202 of the evaluation value (i.e., similarity) indicates “0.8”.

In addition, regarding the update candidate 1012: “Weather: Rainy→Weather: Rainy or Snowy”, it is assumed that the evaluation value 1301 illustrated in FIG. 13 indicates, for example,“4”, and the normalization 1302 of the evaluation values indicates “0.8”. In such a case, the priority 1303 of the update candidate 1012: “Weather: Rainy→Weather: Rainy or Snowy” indicates “0.8” that is the mean value of the value “0.8” of the normalization 1202 of the evaluation value (i.e., similarity) and the value “0.8” of the normalization 1302 of the evaluation value.

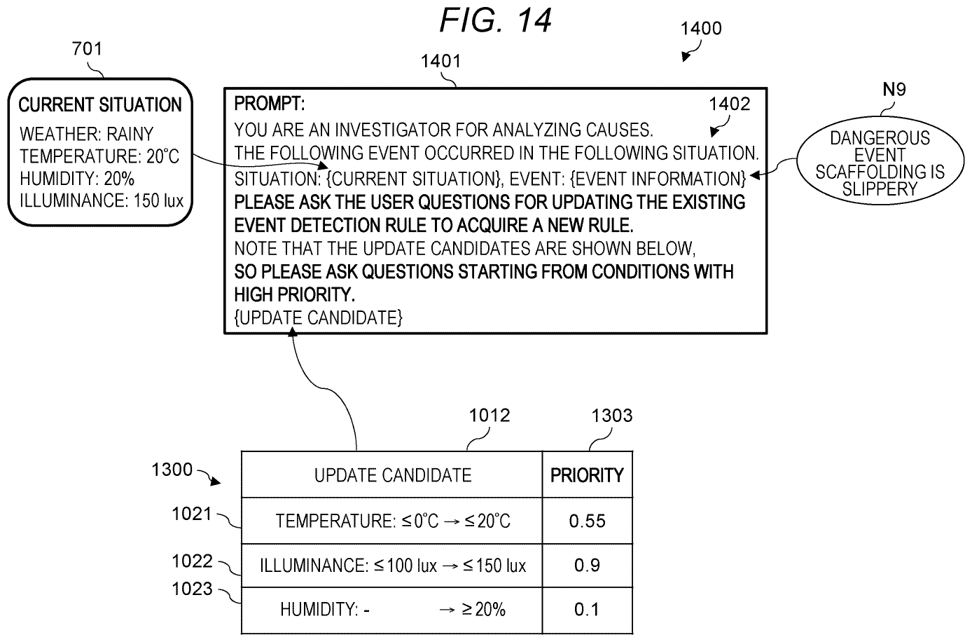

### FIG. 14: Prompt Generation (step S804)

FIG. 14 is an explanatory diagram illustrating an example of prompt generation (step S804) illustrated in FIG. 8. The information processing apparatus 101 generates a prompt 1400 for requesting a correction question related to the event detection rule Ri based on a prompt template 1401 stored in the storage device 202. Specifically, for example, the prompt template 1401 includes a template sentence 1402 for requesting a correction question related to the event detection rule Ri. The template sentence 1402 includes {Current Situation}, {Event Information}, and {Update Candidate} at data setting positions.

The current situation information 701 is set in {Current Situation}. The value 403: “Dangerous Event: Scaffolding is Slippery” of the node N9 whose key 402 of the event detection rule Ri indicates “Event” is set in {Event Information}. The update candidate 1012 and the priority 1303 of the evaluation result 1300 are set in {Update Candidate}. Accordingly, the prompt 1400 is generated.

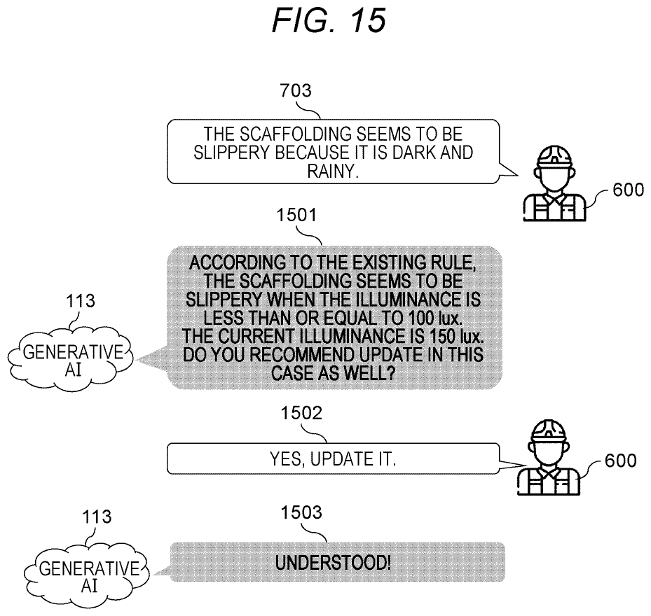

### FIG. 15: Exemplary Conversation Between Generative AI 113 and User 600

FIG. 15 is an explanatory diagram illustrating an exemplary conversation between the generative AI 113 and the user 600. A comment from the user 600 is transmitted as text data from the communication terminal 103 to the information processing apparatus 101. A comment from the generative AI 113 is also transmitted as text data from the information processing apparatus 101 to the communication terminal 103.

As illustrated in FIG. 7, it is assumed that the user 600 confirms the event inference result 702 from the information processing apparatus 101, and makes the comment 703. The comment 703 is transmitted from the communication terminal 103 to the information processing apparatus 101 (step S508).

The information processing apparatus 101 determines from the comment 703 that the user 600 is not satisfied with the event inference result 702 (step S802: No), and generates the prompt 1400 (step S803). The generative AI 113 generates a correction question 1501, which is an answer to the prompt 1400, and the information processing apparatus 101 transmits the correction question 1501 to the communication terminal 103 of the user 600 (steps S805 and S806).

It is assumed that the user 600 confirms the correction question 1501 from the information processing apparatus 101, and inputs an answer 1502 agreeing with the correction question 1501 (step S808). The answer 1502 is transmitted from the communication terminal 103 to the information processing apparatus 101 (step S509).

The generative AI 113 acquires the answer 1502 via the information processing apparatus 101, and generates a response 1503 thereto, and then transmits the response 1503 to the communication terminal 103 of the user 600.

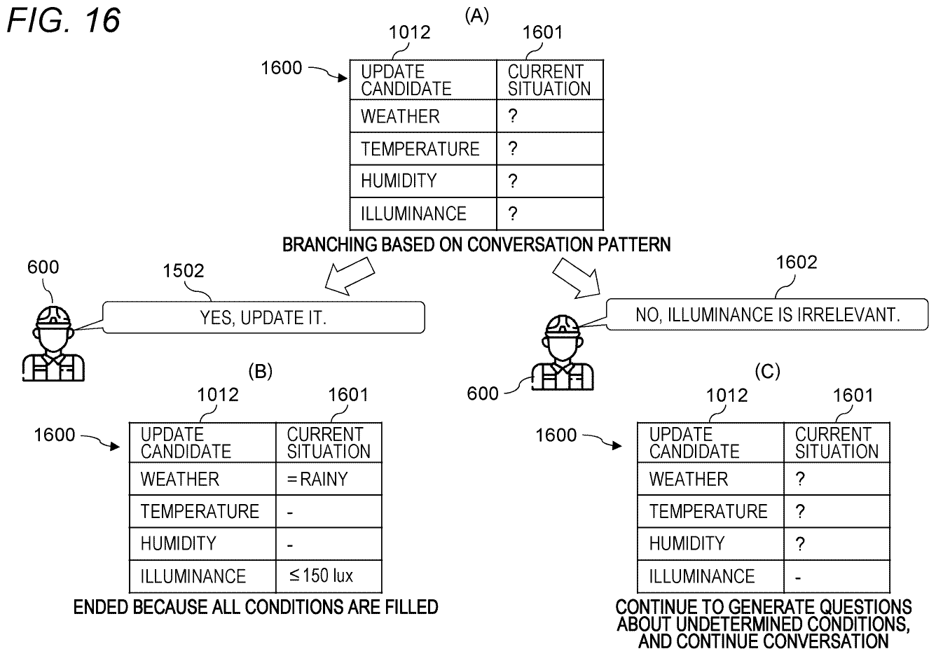

### FIGS. 16A to 16C: Exemplary Conversation Patterns Between Generative AI 113 and User 600

FIGS. 16A to 16C are explanatory diagrams illustrating exemplary conversation patterns between the generative AI 113 and the user 600. FIGS. 16A to 16C illustrate how the weather, temperature, humidity, and illuminance, which are the update candidates 1012, are determined to be update targets depending on conversation patterns.

FIG. 16A illustrates an update candidate table 1600 before the correction question 1501 is acquired. The update candidate table 1600 indicates the update candidates 1012 and their current situations 1601. In FIG. 16A, the current situations 1601 are unknown.

FIG. 16B illustrates the update candidate table 1600 when the answer 1502 agreeing with the correction question 1501 is given. In such a case, the weather and illuminance as the update candidates 1012 are respectively determined to be “Rainy” and “≤150 lux”. In addition, since the user 600 does not agree to the update regarding the temperature and humidity, they are determined as “-” indicating that update is unnecessary. The information processing apparatus 101 updates the event detection rule Ri according to the update candidate table 1600 of FIG. 16B. In such a case, “≤100 lux”, which is the value 403 of the node N5, is updated to “≤150 lux”.

FIG. 16C illustrates the update candidate table 1600 when an answer 1602 disagreeing with the correction question 1501 is given. In such a case, since the update of the illuminance to “≤150 lux ” has not been agreed, the illuminance is determined to be “-” indicating that update is unnecessary. In such a case, the update of the weather, temperature, and humidity remains undetermined. Thus, the conversation between the generative AI 113 and the user 600 is continuously repeated. Such conversation is repeated until all of the current situations 1601 are determined. That is, steps S804 to S811 illustrated in FIG. 8 are repeatedly executed until all of the current situations 1601 are determined.

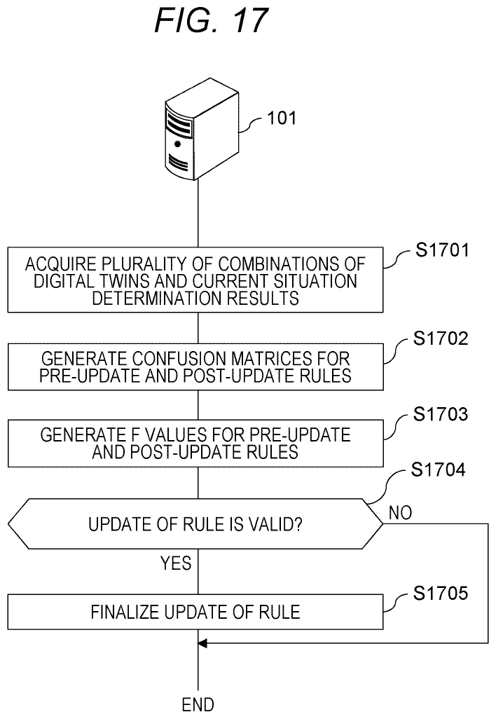

### FIG. 17 Verification Process

FIG. 17 is a flowchart illustrating an exemplary procedure of a verification process performed by the information processing apparatus 101. The verification process is a process of, when an update candidate has been determined to be an update target as illustrated in FIG. 16B, verifying whether the update is valid. In the verification process, the digital twin DB 111 is used. The digital twin DB 111 stores the past time-series digital twins 302, and further stores a current situation determination result for each of the digital twins 302.

The current situation determination result is a determination result about whether an event has occurred in a past situation. Specifically, for example, the current situation determination result is a result of determination made by the user 600 that an event identified by the key 402 and the value 403 in the event detection rule Ri had actually occurred or would occur at that time. The current situation determination result is stored in the digital twin DB 111 in association with the digital twin 302 through an operation of the input device by the user 600.

### (Step S1701)

The information processing apparatus 101 acquires a plurality of combinations of the past digital twins 302 and the current situation determination results. Specifically, for example, the information processing apparatus 101 reads from the digital twin DB 111 a plurality of combinations of the past digital twins 302 and the current situation determination results.

### (Step S1702)

The information processing apparatus 101 generates a confusion matrix of the pre-update and post-update event detection rules Ri. Specifically, for example, the information processing apparatus 101 applies the pre-update and post-update event detection rules Ri to each of the digital twins 302 acquired in step S1701 to acquire pre-update and post-update confusion matrices.

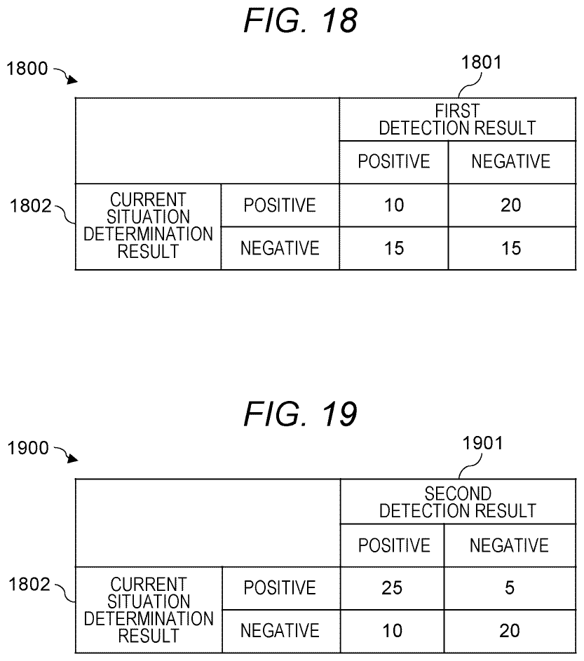

### FIG. 18: First Confusion Matrix Related to Pre-Update Event Detection Rule Ri

FIG. 18 is an explanatory diagram illustrating a first confusion matrix related to the pre-update event detection rule Ri. The first confusion matrix 1800 includes combinations of first detection results 1801 and current situation determination results 1802.

The first detection result 1801 is an event detection result obtained when the pre-update event detection rule Ri is applied to each of the digital twins 302 read in step S1701. “Positive” indicates that an event is detected when the pre-update event detection rule Ri is applied. Specifically, for example, as illustrated in FIG. 6, when the node N9 is reached based on the current situation information 601 of the digital twin 302, the first detection result 1801 indicates “Positive”.

Meanwhile, “Negative” of the first detection result 1801 indicates that an event is not detected when the pre-update event detection rule Ri is applied. Specifically, for example, as illustrated in FIG. 7, when the node N9 is not reached based on the current situation information 701 of the digital twin 302, the first detection result 1801 indicates “Negative”.

The current situation determination result 1802 is a result of determination made by the user 600 as to whether an event has occurred at the time of generation of the past digital twin 302 to which the pre-update event detection rule Ri is applied. In the case of the event detection rule Ri, the event corresponds to the “Dangerous Event: Scaffolding is Slippery” of the node N9.

If the user 600 has determined at that time that the “Dangerous Event: Scaffolding is Slippery” had occurred or would occur, “Positive” is associated with the past digital twin 302.

Meanwhile, if the user 600 has not determined at that time that the “Dangerous Event: Scaffolding is Slippery” had occurred or would occur, “Negative” is associated with the past digital twin 302.

The information processing apparatus 101 generates the first confusion matrix 1800 by counting the number of cases where both the first detection result 1801 and the current situation determination result 1802 are “Positive”, the number of cases where the first detection result 1801 is “Positive” and the current situation determination result 1802 is “Negative”, the number of cases where the first detection result 1801 is “Negative” and the current situation determination result 1802 is “Positive”, and the number of cases where both the first detection result 1801 and the current situation determination result 1802 are “Negative”, among the number of digital twins 302 read in step S1701.

### FIG. 19: Second Confusion Matrix Related to Post-Update Event Detection Rule Ri

FIG. 19 is an explanatory diagram illustrating a second confusion matrix related to the post-update event detection rule Ri. The second confusion matrix 1900 includes combinations of second detection results 1901 and current situation determination results 1802.

The second detection result 1901 is the same as the first detection result 1801 except that the applied event detection rule Ri is the post-update event detection rule Ri.

The information processing apparatus 101 generates the second confusion matrix 1900 by counting the number of cases where both the second detection result 1901 and the current situation determination result 1802 are “Positive”, the number of cases where the second detection result 1901 is “Positive” and the current situation determination result 1802 is “Negative”, the number of cases where the second detection result 1901 is “Negative” and the current situation determination result 1802 is “Positive”, and the number of cases where both the second detection result 1901 and the current situation determination result 1802 are “Negative”, among the number of digital twins 302 read in step S1701.

### (Step S1703)

Referring back to FIG. 17, the information processing apparatus 101 calculates an F value for each of the confusion matrices of the pre-update and post-update event detection rules Ri. Regarding the first confusion matrix 1800 of the pre-update event detection rule Ri, for example, recall (i.e., recall ratio), precision (i.e., matching ratio), and the F value are calculated as follows.

Recall (i.e., recall ratio)=10/30=0.33

Precision (i.e., matching ratio)=10/25=0.4

The F value=2/(1/0.33+1/0.4)=0.36

Similarly, regarding the second confusion matrix 1900 of the post-update event detection rule Ri, for an example, the recall (i.e., recall ratio), the precision (i.e., matching ratio), and the F value are calculated as follows.

Recall (i.e., recall ratio)=25/30=0.83

Precision (i.e., matching ratio)=25/35=0.71

The F value=2/(1/0.83+1/0.71)=0.77

### (Step S1704)

The information processing apparatus 101 determines the validity of the update of the event detection rule Ri. Specifically, for example, the information processing apparatus 101 determines the validity of the update of the event detection rule Ri based on the F value obtained from the first confusion matrix 1800 of the pre-update event detection rule Ri and the F value obtained from the second confusion matrix 1900 of the post-update event detection rule Ri. A larger F value indicates better performance. Therefore, the information processing apparatus 101 determines that the update is not valid if the F value obtained from the first confusion matrix 1800 of the pre-update event detection rule Ri is larger (step S1704: No), and determines that the update is valid if the F value obtained from the second confusion matrix 1900 of the post-update event detection rule Ri is larger (step S1704: Yes).

In the case of the above example, the F value obtained from the first confusion matrix 1800 of the pre-update event detection rule Ri is “0.36”, and the F value obtained from the second confusion matrix 1900 of the post-update event detection rule Ri is “0.77”. Therefore, since the F value obtained from the second confusion matrix 1900 of the post-update event detection rule Ri is larger, the information processing apparatus 101 determines that the update of the event detection rule Ri is valid (step S1704: Yes).

In the above example, if the F value obtained from the second confusion matrix 1900 of the post-update event detection rule Ri is larger, it is determined that the update of the event detection rule Ri is valid (step S1704: Yes). However, the information processing apparatus 101 may determine that the update of the event detection rule Ri is valid if a difference obtained by subtracting the F value obtained from the first confusion matrix 1800 of the pre-update event detection rule Ri from the F value obtained from the second confusion matrix 1900 of the post-update event detection rule Ri is greater than or equal to a threshold (step S1704: Yes).

If it is determined that the update is valid (step S1704: Yes), the process proceeds to step S1705. If it is determined that the update is not valid (step S1704: No), the verification process ends without finalizing the update of the event detection rule Ri. Therefore, the event detection rule Ri is held in a pre-update state in the rule DB 112.

### (Step S1705)

The information processing apparatus 101 finalizes the update of the event detection rule Ri, and writes the updated event detection rule Ri over the rule DB 112 for storage. Note that the information processing apparatus 101 may hold the pre-update event detection rule Ri. However, the event detection rule Ri to be applied is the post-update event detection rule Ri. Executing the verification process in this manner can optimize the update of the event detection rule Ri.

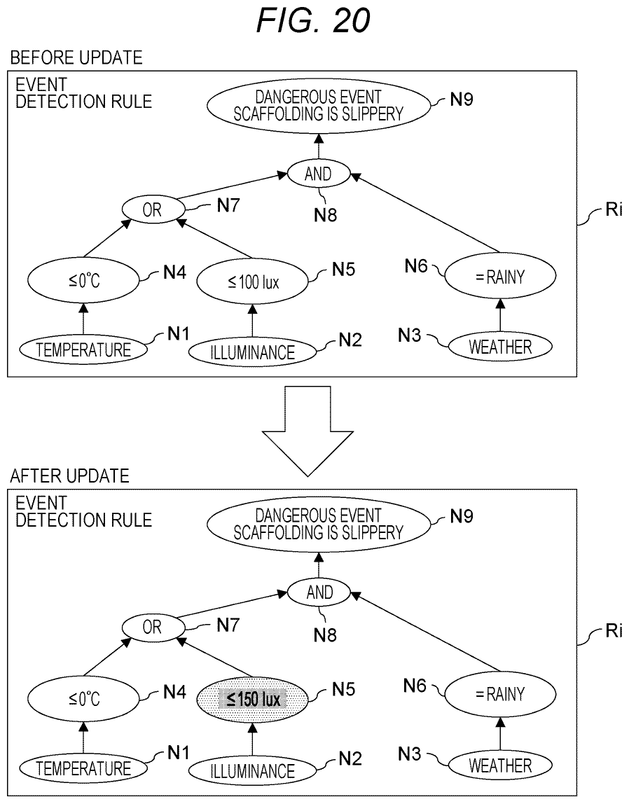

### FIG. 20: Example of Update of Event Detection Rule Ri

FIG. 20 is an explanatory diagram illustrating an example of update of the event detection rule Ri. In the post-update event detection rule Ri, the value of the node N5 has been updated from “≤100 lux” to “≤150 lux”.

As described above, according to the present embodiment, it is possible to provide appropriate update candidates 1012 when a gap occurs between the event inference (step S504) performed based on the existing event detection rule Ri and the actual event (i.e., the current situation information of the digital twin 302). Specifically, for example, by providing the priority 1303, optimal update candidates 1012 to be updated in the event detection rule Ri with respect to an unspecified number of pieces of current situation information in the real world are revealed as the implicit knowledge of the user 600. This can reduce the number of times of interaction with the user 600, and reduce work load.

In the above-described embodiment, the communication terminal 103 executes steps S505 to S508, and the information processing apparatus 101 executes steps S801 and S802, but such processes may be omitted.

In addition, in the above-described embodiment, after calculating priority in the priority calculation process (step S803), the information processing apparatus 101 executes prompt generation (step S804), but the information processing apparatus 101 may transmit the priority to the communication terminal 103. In such a case, the user 600 inputs an answer with reference to the priority. The communication terminal 103 receives an input of the answer (step S808), and transmits the answer to the information processing apparatus 101 (step S809).

In the above-described embodiment, interactive communication is executed between the information processing apparatus 101 and the communication terminal 103, but the communication terminal 103 may not be used. In such a case, the information processing apparatus 101 displays an event inference result and a correction question on a display device, which is an example of the output device 204, and the user 600 directly inputs a comment and an answer into the information processing apparatus 101 by operating the input device 203.

Note that the present invention is not limited to the above-described embodiment, and includes various modifications and equivalent configurations within the spirit of the appended claims. For example, the above-described embodiment has been described in detail for easy understanding of the present invention, and the present invention is not necessarily limited to those having all of the described configurations. In addition, a part of the configuration of one embodiment may be replaced with the configuration of another embodiment. Further, the configuration of another embodiment may be added to the configuration of a given embodiment. Furthermore, a part of the configuration of each embodiment may be added to, deleted from, or replaced with other configurations.

Some or all of the above-described configurations, functions, processing units, processing means, and the like may be implemented with hardware by, for example, designing them with integrated circuits, or may be implemented with software such that a processor interprets and executes a program for implementing each function.

Information such as a program, a table, and a file for implementing each function can be stored in a storage device such as a memory, a hard disk, or a solid state drive (SSD), or in a recording medium such as an integrated circuit (IC) card, an SD card, or a digital versatile disc (DVD).

The control lines and the information lines indicate those that are considered to be necessary for the description, and not all of the control lines and the information lines that are necessary for the implementation are necessarily illustrated. In practice, it may be considered that almost all the configurations are connected to each other.

What is claimed is:

1. An information processing apparatus comprising:
a processor that executes a program, and a storage device that stores the program, wherein
the storage device stores an event detection rule for detecting an event based on a combination of satisfactions of conditions, and
the processor executes
an identifying process of identifying an update candidate by applying a situation of a monitoring target to the event detection rule, the update candidate being a combination of an update target whose condition has not been satisfied in the event detection rule and update information that has made the condition of the update target in the situation unsatisfied, and
a calculation process of calculating a priority for each update candidate identified through the identifying process.

2. The information processing apparatus according to claim 1, wherein
the processor executes an inference process of inferring whether the event occurs in the monitoring target by applying the situation to the event detection rule, and
in the identifying process, the processor identifies an update candidate to be updated from the event detection rule for each condition based on an event inference result of the inference process.

3. The information processing apparatus according to claim 2, wherein
the processor executes
a first acquisition process of acquiring a comment indicating a reaction to the event inference result as a result of the event inference result having been output, and
a determination process of determining whether the comment acquired through the first acquisition process is satisfied with the event inference result, and
in the identifying process, the processor identifies the update candidate if it has been determined through the determination process that the comment is satisfied with the event inference result.

4. The information processing apparatus according to claim 1, wherein
in the calculation process, the processor calculates the priority based on a similarity between the update target and the situation and a likelihood of an update of the update target to the situation.

5. The information processing apparatus according to claim 4, wherein
in the calculation process, the processor acquires, as a result of outputting to generative AI a prompt for requesting an evaluation value of the likelihood of the update, the evaluation value obtained as an answer from the generative AI, and calculates the priority based on the similarity and the evaluation value.

6. The information processing apparatus according to claim 1, wherein
the processor executes a generation process of generating a prompt for requesting a question for correcting the event detection rule to generative AI, based on the situation, the event, and the update candidate.

7. The information processing apparatus according to claim 6, wherein
the processor executes
a second acquisition process of acquiring the question from the generative AI as a result of outputting the prompt generated through the generation process to the generative AI,
a third acquisition process of acquiring an answer to the question as a result of outputting the question acquired through the second acquisition process, and
an update process of updating the event detection rule based on the answer acquired through the third acquisition process.

8. The information processing apparatus according to claim 7, wherein
the processor executes a verification process of determining validity of the update of the event detection rule through the update process, and finalizing the update of the event detection rule if the update is determined to be valid.

9. The information processing apparatus according to claim 8, wherein
in the verification process, the processor determines the validity of the update of the event detection rule based on a first detection result of the event in the monitoring target obtained by applying a past situation of the monitoring target to the event detection rule, a second detection result of the event in the monitoring target obtained by applying the past situation to the event detection rule that has been updated, and a determination result as to whether the event has occurred in the past situation.

10. The information processing apparatus according to claim 9, wherein
in the verification process, the processor generates a first confusion matrix based on the first detection result and the determination result as to whether the event has occurred in the past situation, generates a second confusion matrix based on the second detection result and the determination result as to whether the event has occurred in the past situation, and determines the validity of the update of the event detection rule based on the first confusion matrix and the second confusion matrix.

11. An information processing method executed by an information processing apparatus including a processor that executes a program, and a storage device that stores the program, wherein
the storage device stores an event detection rule for detecting an event based on a combination of satisfactions of conditions, and
the processor executes
an identifying process of identifying an update candidate by applying a situation of a monitoring target to the event detection rule, the update candidate being a combination of an update target whose condition has not been satisfied in the event detection rule and update information that has made the condition of the update target in the situation unsatisfied, and
a calculation process of calculating a priority for each update candidate identified through the identifying process.

12. A recording medium storing a program that causes a processor to execute
an identifying process of identifying an update candidate by applying a situation of a monitoring target to an event detection rule for detecting an event based on a combination of satisfactions of conditions, the update candidate being a combination of an update target whose condition has not been satisfied in the event detection rule and update information that has made the condition of the update target in the situation unsatisfied, and
a calculation process of calculating a priority for each update candidate identified through the identifying process.
